(19) United States
(12) Patent Application Publication
(10) Pub. No.: US 2022/0412656 A1
(43) Pub. Date: Dec. 29, 2022

(54) THERMAL LAUNDER FOR THE TRANSFER OF WHITE METAL IN A SMELTING FURNACE

(71) Applicant: CODELCOTEC SPA, Región Metropolitana, Santiago (CL)

(72) Inventors: Leonel CONTRERAS ROJAS, Región Metropolitana, Santiago (CL); Gonzalo RAMIREZ TROXLER, Región Metropolitana, Santiago (CL); Carla ALFARO JAQUE, Región Metropolitana, Santiago (CL); Jorge ROJAS VILO, Región Metropolitana, Santiago (CL)

(21) Appl. No.: 17/756,558

(22) PCT Filed: Nov. 26, 2020
(86) PCT No.: PCT/CL2020/050162

§ 371 Date: May 26, 2022

(30) Foreign Application Priority Data
Nov. 26, 2019 (CN) 201911172099.2

(51) Int. Cl. F27D 3/14; B22D 35/00

(52) U.S. Cl. CPC F27D 3/145; B22D 35/00

(57) ABSTRACT

This invention patent application addresses a thermal launder that allows the transport of white metal (WM) or other molten material to a converter or furnace or from these to a transfer pot while keeping it molten, with a viscosity that allows the material to continue flowing en route.

This invention patent application addresses a thermal launder that allows the transport of white metal (WM) or other molten material to a converter or furnace or from these to a transfer pot while keeping it molten, with a viscosity that allows the material to continue flowing en route.

### BACKGROUND

Currently, launders to transport white metal or blister copper are manufactured from refractory material and the white metal is transported via these but solidifies, which slows its free circulation and reduces copper recovery and the availability of furnaces. Solidification build-up is resolved from the launder with the manual or mechanical intervention of workers at temperatures over 70° C. in remediation areas, which can increase the frequency of accidents. Additionally, a lot of cleaning must be done due to the deterioration of the launders caused by the passage of the WM, which increases the frequency at which maintenance must be done. Also, reliability is reduced due to breaks.

The prior art describes various solutions to heat the launders that transport molten material. The publication of U.S. Pat. No. 6,973,955 describes a launder for the transport of aluminum that has devices to transfer heat via radiation and conduction from the lower part and sidewall of the launder using electrical resistors. This publication highlights the use of a PID control system for thermal control. Unlike the solution proposed in the invention, this publication does not mention the launder construction having multiple layers that allow its temperature to be maintained, achieving a decrease in the energy required to maintain the white metal or material in a molten state.

The publication of patent US2009078723 A1 describes a launder that has devices to transfer heat via radiation from the upper part of the launder. It has electrical resistors and a gas burner. It is used for blister copper and other metals. Also, it has a gas containment cover Like the previous publication, this publication does not mention the launder construction having multiple layers that allow its temperature to be maintained, achieving a decrease in the energy required to maintain the white metal or material in a molten state.

The registration for patent CL 48220 describes a modular thermal induction launder system to carry, contain or transport molten metal, slag or other elements that are in either a molten or a solid state and that is capable of conserving or raising the temperature of the transported or contained element, in or via the launder, making it more difficult for accretions to form on the launder walls thanks to the temperature of the contained or transported element being maintained or raised. It has the means to maintain or raise the temperature of the contained or transported elements, which is comprised of a closed launder that serves as the core of a magnetic induction coil. Said core is coaxially encircled by an induction coil. Operationally, the core and coil are hermetically sealed longitudinally to optimize heat conversion. It is a modular system formed by at least one independent unit or module with coaxial connections to other units to increase the length of the molten metal conductor launder and has the means to open and separate the modular launder system into two longitudinal portions for the inspection and maintenance of the launder. Unlike the proposed solution, the publication addresses a launder that uses induction to raise the temperature, rather than the composition of the launder itself. The proposed invention has multiple layers that allow the temperature of the molten material to be maintained with lower energy consumption.

Thus, the need arises to have a thermal launder to transport molten white metal that allows the material to remain molten for its expedited transport to a casting pot or processing furnace, so as to have operations that are safe and highly durable and maintenance that is well-spaced in time and consumes less energy. The proposed launder is the type wherein the heating element is on the upper part. The middle and lower areas, that is to say where the white metal or molten material is transported, consist of multiple layers that allow the molten white metal to be transported more efficiently.

### BRIEF DESCRIPTION OF THE FIGURES

FIG. 1: represents a profile diagram of a thermal launder between a CT converter and a transport pot.

FIG. 2: represents a cross-section view of the invention's thermal launder.

FIG. 3: represents an exploded view of the invention's thermal launder.

FIG. 4: represents a perspective view of the middle and lower areas of the invention's thermal launder.

### DETAILED DESCRIPTION OF THE INVENTION

The thermal launder for the transport of white metal (WM) or other molten material to a converter or furnace, keeping it in a molten state and conserving its viscosity en route, is composed of a structure (1) comprised of a cover (2) and a transport duct (3), which form, when the cover (2) is closed, the thermal launder itself. In the upper part of the cover (2), heating elements (4) are installed, surrounded by the upper insulation (5), which is covered by a structural housing (6).

The transport duct (3) is comprised of four elements arranged in series, which are defined by a transport layer (7) comprised of a material that has high thermal conductivity and high chemical and mechanical strength, such as, for example, silicon carbide (SiC), the function of which is to resist abrasion caused by the molten material. Then there is a refractory layer (8) comprised of a refractory cement material whose function is to provide mechanical compressive strength and to serve as a thermal insulator. Next there is an insulation layer (9) comprised of an insulating material, mainly ceramic fiber. It functions as the thermal insulation to protect the next layer from high temperatures and corresponds to a structural layer (10) comprised of a carbon steel material. Its function is to provide mechanical and structural strength, in addition to offering protection from external impacts due to its assembly in the plant.

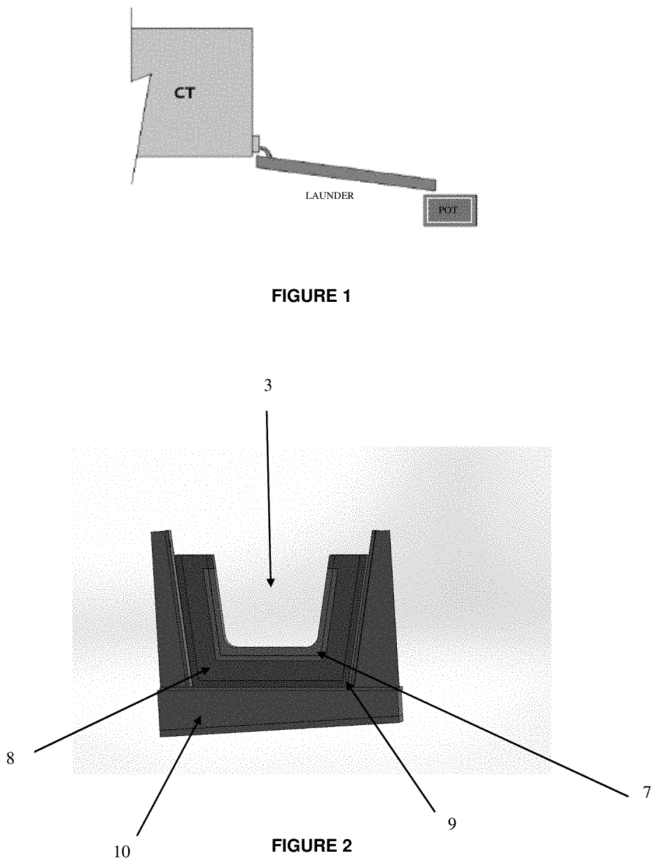

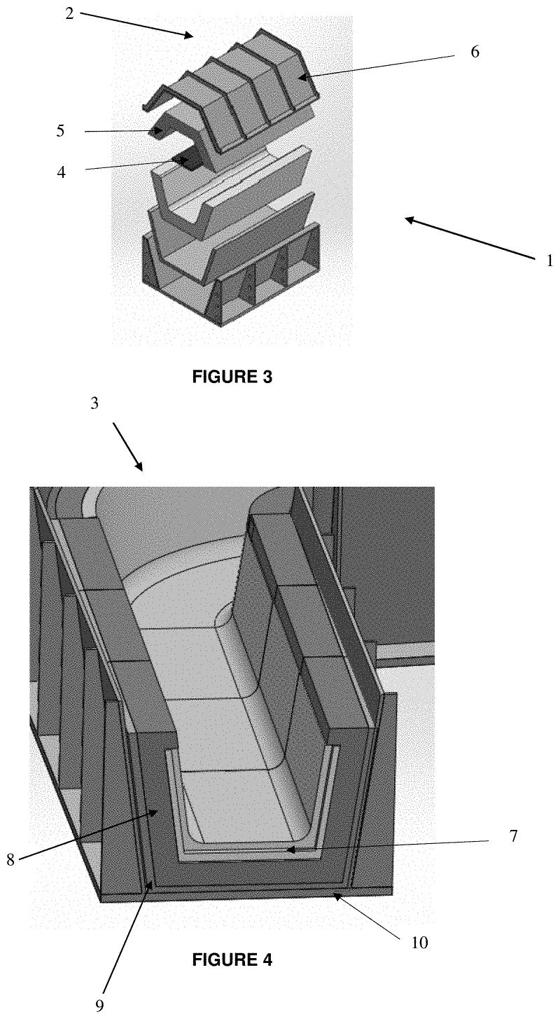

The thermal launder can be placed between a melting furnace and a conversion furnace. For example, it can be placed between a Teniente converter and a continuous converter or between a melting converter and a transfer pot, as illustrated conceptually in FIG. 1.

The advantages that this invention's solution represents consist of:
It is encapsulated.
Since it does not have heating elements in the area under the heating system, it is not subject to leaking white metal or the material being transported.
Quick access to the heating elements.
In the event of an operational failure of the heaters, the system can continue draining white metal without stopping the process and without affecting the availability of the molten material in subsequent processes.
There is greater efficiency since the launder contact surface is heated directly with the white metal or molten metal.
This set of elements allows the temperature to be conserved along the entire route, maintaining the fluidity of the material and decreasing accretions, thus [reducing] operators' exposure to repairs.

1. Thermal launder that allows white metal (WM) or other molten material to be transported from a melting furnace to a converter furnace, or from a melting furnace to a transfer pot, keeping it in a molten state and conserving its viscosity throughout the route, which is composed of a structure (1) comprised of a cover (2) and a transport duct (3), which form, when said cover (2) is closed, the thermal launder itself. In the upper part of said cover (2), heating elements (4) are installed, surrounded by the upper insulation (5), which is covered by a structural housing (6), CHARACTERIZED in that said transport duct (3) is comprised of four elements arranged in series, which are defined by a transport layer (7), then a refractory layer (8), followed by an insulation layer (9) and a structural layer (10).

2. Thermal launder that allows the transport of white metal (WM) or other molten material in accordance with claim 1, CHARACTERIZED in that said transport layer (7) is comprised of a material that has high thermal conductivity and high chemical and mechanical strength.

3. Thermal launder that allows the transport of white metal (WM) or other molten material in accordance with claim 1, CHARACTERIZED in that said material is silicon carbide or SiC.

4. Thermal launder that allows the transport of white metal (WM) or other molten material in accordance with claim 1, CHARACTERIZED in that said refractory layer is composed of a refractory cement material that provides mechanical compressive strength and serves as a thermal insulator.

5. Thermal launder that allows the transport of white metal (WM) or other molten material in accordance with claim 1, CHARACTERIZED in that said insulating layer is composed of an insulating material, mainly ceramic fiber.

6. Thermal launder that allows the transport of white metal (WM) or other molten material in accordance with claim 1, CHARACTERIZED in that said structural layer (10) is composed of a carbon steel material.
